(19) United States
(12) Patent Application Publication
(10) Pub. No.: US 2008/0223212 A1
(43) Pub. Date: Sep. 18, 2008

(54) Reducing moisture content of compressed air

(76) Inventors: Robert O. Crowder, Little Canada, MN (US); John H. Burban, Lake Elmo, MN (US)

Correspondence Address: Carl L. Johnson;Jacobson and Johnson, Suite 285, One West Water Street, St. Paul, MN, 55107-2080, US

(21) Appl. No.: 12/075,141

(22) Filed: Mar. 10, 2008

Related U.S. Application Data
(60) Provisional application No. 60/918,421, filed on Mar. 16, 2007.

(51) Int. Cl. B01D 53/22; B01D 46/10; B01D 24/00; B01D 39/00; B01D 50/00

(52) U.S. Cl. 95/52; 55/520; 55/527; 55/385.3; 55/522

(57) ABSTRACT

A system and method for removing moisture from compressed air with the system having a membrane for passage of water vapor therethrough while preventing the flow of air therethrough and a diverter for diverting and reducing the pressure of a portion of the compressed air to enable the air at a reduced pressure to flow past one side of the membrane while the compressed air flows by the opposite side of the membrane to allow water vapor from the compressed air to pass through the membrane to the compressed air at the reduced pressure thereby providing for on-the-go reduction of amount of moisture in the compressed air.

### CROSS REFERENCE TO RELATED APPLICATIONS

This application claims priority to currently pending U.S. Provisional Application Ser. No. 60/918,421; filed on Mar. 16, 2007; titled REDUCING MOISTURE CONTENT OF COMPRESSED AIR.

### FIELD OF THE INVENTION

This invention relates generally to the supplying compressed air and more specifically, to an apparatus and method for the removal of water vapor from compressed air to inhibit or prevent freezing of the system during use in freezing or subfreezing conditions.

### STATEMENT REGARDING FEDERALLY SPONSORED RESEARCH OR DEVELOPMENT

None

### REFERENCE TO A MICROFICHE APPENDIX

None

### BACKGROUND OF THE INVENTION

Traditionally, very little attention has been paid to the quality of the compressed air used in filling car tires. These systems may operate by taking air from a compressed air system of a garage or from an air compressor. In either case, when filling a tire the compressed air is generally run through a flexible air hose located outside of a building.

The air hose, being outside of the building, may bring the compressed air within the air hose to a temperature approaching the ambient outdoor temperature. If the compressed air temperature is below the dew point of the compressed air, it can produce water condensation in the hose. The condensation tends to collect in low portions of the hose, or in areas where there is rapid cooling, such as an orifice. Generally, air flow through restrictive orifices produces additional cooling, that may bring the air temperature below the ambient environmental temperature. In the winter months, the ambient outdoor temperature, and thus the air hose, may be at or below the freezing temperature of water. In such cases, the water in the air hose can freeze and block the air passage in the air hose.

When frozen condensation blocks the air passage in the air hose or any orifice within the air supply system it can block air flow through the air hose thus rendering the system inoperative.

### SUMMARY OF THE INVENTION

The invention provides a method for drying air or removing moisture from compressed air to produce dried air that inhibits or prevents freezing of a tire filling system which is at or below freezing conditions and a system for transferring water vapor from the compressed air to the environment prior to the air-cooling in the air hose by using a membrane device, which has a high selectivity for water vapor over air to allow permeation of water vapor from the air on a high-pressure side of a membrane to the air on a low-pressure side of a membrane. A portion of the dried air can be decompressed and thus further dried and used as a sweep to carry away the water which permeates across the membrane. The sweep can also be supplied by decompressing a portion of the supplied air, but this may render the sweep as dry or less dry as the decompressed dried air and may lead to slightly worse membrane device performance.

The system may include a source of compressed air, a membrane device having a membrane having a high selectivity for water vapor over air to allow permeation of water vapor from the high-pressure compressed air side of the membrane to the low-pressure side, a sweep control device having a high-pressure inlet and a low-pressure outlet, and an air hose for delivering compressed air from an outlet of the membrane device to a nozzle. The membrane device can include a first fluid pathway extending from a first inlet to a first outlet and a second fluid pathway extending from a second inlet to a second outlet of the membrane with the fluid pathways separated by the selective membrane. The first fluid pathway can function to support a stream of air having a higher partial pressure of water vapor than a stream of air supported by the second fluid pathway. The first inlet of the membrane device is in fluid communication with the source of compressed air. The sweep control device includes a high-pressure inlet and a low-pressure outlet. The low-pressure outlet of the sweep control device is in fluid communication with the second inlet of the membrane device. An air reservoir can provide for either inline or offline storage of dried compressed air.

The invention may also include an air station for inhibiting or minimizing the condensation of moisture in a pneumatic tire filling system comprising a housing having a high-pressure inlet and a high-pressure outlet, a low-pressure inlet and a low-pressure outlet and a source of compressed air for directing compressed air into the high-pressure inlet. The air station may also include a selective membrane located in the housing with the membrane having a high-pressure chamber on a first side of the membrane and a low-pressure chamber on a second side of the membrane. The air station may further include a diverter for directing a portion of the compressed air into a bypass to expand a portion of the compressed air to a lower pressure and then directing the portion of the compressed air at the lower pressure into the low-pressure chamber to enable moisture in the air in the high-pressure chamber to pass through the membrane into the air in the low-pressure chamber thereby reducing the moisture content of the compressed air.

### BRIEF DESCRIPTION OF THE DRAWINGS

FIG. 1 shows a schematic diagram of an embodiment of a membrane device system where a membrane device is used to remove the water vapor from the compressed air;

FIG. 1A shows a cross section view of a compressed air moisture reduction system such as an air station used for filling tires or operating pneumatic tools;

FIG. 2 is a system diagram of an example of an embodiment of the invention, where a membrane device is used with an off line dead-ended reservoir to slow pressurization and depressurization;

FIG. 3 shows a schematic diagram of an example of an embodiment of a membrane device system where a membrane device is used with an inline flow-through reservoir to slow pressurization;

FIG. 4 shows a schematic diagram of an example of an embodiment of a membrane device system where a membrane device is used with a reservoir that supplies the sweep air controller; and

FIG. 5 shows a schematic diagram of an example of an embodiment of a membrane device system where a membrane device is used with a flow-through reservoir and a pressure relief valve.

### DESCRIPTION OF THE PREFERRED EMBODIMENT

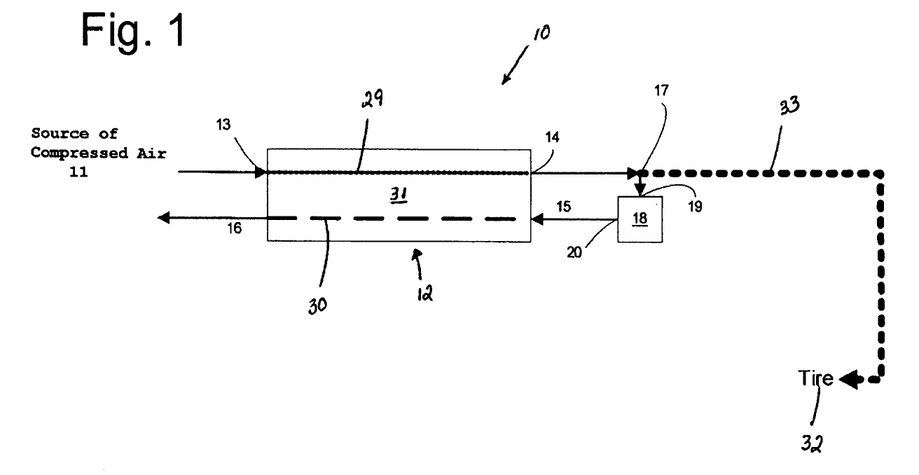

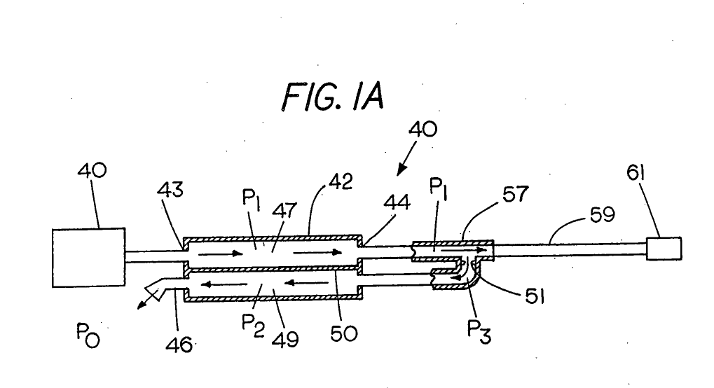

FIG. 1 shows a schematic diagram of a membrane device system or compressed air station 10 for supplying dried compressed air useable in air supply systems such as tire filling systems or the like that are exposed to freezing or subfreezing environments. Membrane device system 10 generally includes a source of compressed air 11, a membrane device 12, and a sweep control device 18. Membrane device 12 includes a first fluid pathway having an air inlet 13, an air outlet 14, and a second fluid pathway having an air inlet 15, and an outlet 16 with the first fluid pathway and the second fluid pathway located on opposite side of a membrane 31. In the membrane device system 10 a portion of the high-pressure compressed air discharging from the first fluid pathway in membrane device 12 is captured and diverted into the second fluid pathway. The portion of the high-pressure compressed air that is diverted to the second fluid pathway is reduced in pressure to form a stream of air at a reduced pressure which is used to dry the high pressure compressed air on the opposite side of a selective membrane by allowing water vapor to migrate from the high pressure side of membrane 31 to the low pressure side of membrane 31.

As shown in FIG. 1, the compressed air source 11 is in fluid communication with air inlet 13 of membrane device 12. Membrane device 12 includes a first fluid pathway 29, which is shown as a dotted line extending from air inlet 13 to air outlet 14 and a second fluid pathway 30, which is shown as a dashed line, extending from second inlet 15 to second outlet 16.

Fluid pathways 29 and 30 are separated by a selective membrane 31 having selectivity for water vapor over oxygen and nitrogen. Although the level of selectivity of the membrane for water vapor over oxygen and nitrogen may be more or less in the example of FIG. 1 the selective membrane 31 which provides a selectivity of water vapor over both nitrogen and oxygen, which are the principal components of air, is at least 10.

In the embodiment of FIG. 1, water vapor is free to permeate across the selective membrane 31 from a high partial pressure of water vapor on one side of the membrane 31 to a lower partial pressure of water vapor on the opposite side of membrane 31, while the membrane inhibits or prevents oxygen and nitrogen from permeating across the selective membrane 31. The membrane 31 in membrane device 12 may include various types of membrane shapes including a flat-sheet membrane, a spiral-wound membrane, a hollow-fiber membrane, or any other membrane configuration or combinations thereof.

FIG. 1 shows first fluid pathway 29 carrying a stream of compressed air flowing counter current to a stream of air carried by second fluid pathway 30, which is an example of a preferred air flow configuration that can produce enhanced performance. Membrane device system 10 may also be operated with streams of air on opposite sides of membrane 31 flowing co-currently or cross-currently to each other.

In the operation of membrane device system 10 the compressed air from source of compressed air 11 flows through the membrane device 12 via first fluid pathway 29. As the compressed air moves through first fluid pathway 29, a portion of the water vapor in the stream of compressed air permeates across the selective membrane 31 to the air in the second fluid pathway 30, which has a lower partial pressure of water vapor. The lower partial pressure of water vapor of the air in fluid pathway is maintained by a dry sweep airflow that flows through the second fluid pathway 30.

FIG. 1 shows the air outlet 14 from the membrane device 12 is in fluid communication with a tee 17, which is in fluid communication with both a sweep control device 18 and with a valve stem (not shown) on a tire 32, through an air hose 33, which is shown as a heavy dashed line. While cooling of the compressed air in the air hose 33 to below freezing can occur as the compressed air flows to tire 32, the removal of at least a portion of the water vapor in the compressed air by the membrane device 12 can reduce or eliminate the presence of water vapor in the air hose 33 and hence reduce the potential for ice blocking the passage in air hose 33 when the outside temperatures surrounding the air hose is at or below freezing. Thus, in the example of FIG. 1 a dehydrated or dried compressed air, which discharges from membrane device 12, is directed into the air hose 33 to prevent or minimize blockage of the air passage in the air hose by ice forming from condensing water vapor in the air hose.

FIG. 1 shows the sweep control device 18 has a high-pressure inlet 19, which is supplied by the dried, compressed air flowing through the fluid pathway 29. The sweep control device 18 allows a portion of the dried compressed air from fluid pathway 29 to decompress as it passes from the high-pressure inlet 19 to the low-pressure outlet 20 of the sweep control device 18. The decompression reduces the concentration of water vapor in the air since the volume of air increases while the amount of water vapor in the air remains constant. The sweep control device 18 may be as simple as a fixed orifice or a number of orifices or a restricted air passage in membrane device 12. The sweep control device may be external to the membrane device 12, as shown, or it may be integral to the membrane device 12. The sweep control device 18 may also be a simple design that allows air flow therethrough which is proportional to the absolute pressure of the compressed air or to the pressure differential between the high pressure compressed air on one side of membrane 31 and the reduced pressure compressed air on the opposite side of membrane 31. Other examples may include a complex design that allows more flow at lower pressure and less flow at higher pressure, in order to enhance performance of the membrane device 12. FIG. 1 shows the outlet 20 from the sweep control device 18 is in fluid communication with the air inlet 15 of the membrane device 12. While sweep control device 18 can be simple orifice such as 51 shown in FIG. 1A other devices for reducing the pressure of the compressed air are commercially available, for example pressure or flow regulators can also be used to reduce the pressure of the high pressure compressed air before the air is introduced at a reduced pressure into the second fluid pathway.

FIG. 1A shows a cross section view of a compressed air moisture reduction system 40 or air station. System 40 includes a compressor 41 that compresses atmospheric air to a pressure P₁ and directs the compressed air into a housing comprising a membrane dehumidifier 42. As air is compressed the mole fraction of water vapor in the compressed air remains constant, but the concentration of water vapor in the air increases due to compression of the air. The increase in water vapor concentration increases the dew point of the air. If the dew point increases above the temperature of the air, moisture or water vapor can condense from the compressed air in the form of liquid water. In air supply systems operating under freezing conditions, such as found in outside air supply systems, the water can freeze and block the air passages in the air hose thus rendering the compressed air system inoperative.

To reduce the amount of moisture in the compressed air and thus inhibit or prevent condensation a portion of the compressed air is removed and allowed to flow through a membrane device or membrane dehumidifier 42. Membrane dehumidifier 42 comprises a housing 42 having a high-pressure compressed air inlet 43 on one end and a high-pressure compressed air outlet 44 on the opposite end. Housing 42 includes a first high-pressure chamber 47 separated from a low-pressure chamber 49 by a flat sheet membrane 50. Membranes which allow passage of water vapor therethrough but not air are known in the art and commercially available

In operation of the dehumidifying system 40 a high-pressure compressed air, at pressure P_{1.}, flows through the first high-pressure chamber 47 through outlet 44 and into a sweep control device comprising a flow diverter or tee 57 having a bypass orifice 51. The orifice 51 restricts the offline flow of compressed air allowing compressed air to flow unrestricted to nozzle 61 through an air hose 59. The offline flow of a portion of the compressed air through orifice 51 is directed into the low-pressure chamber 49. In the example shown sweep control device 57 is unadjustable as the size or shape of the orifice 51 remains the same. In other examples the sweep control device may be adjustable, for example through varying the size or shape of the orifice 51 to thereby vary the pressure or flow of the compressed air in the chamber 49. In still other examples the sweep control device such as a pressure regulator can be used to vary the pressure of the portion of compressed air directed into the chamber 49.

The portion of the compressed air that flows through the orifice 51, which is referred to as the bypass air, is allowed to expand thus reducing the concentration of water vapor in the bypass air and consequently the dew point in the bypass air. Thus, after the bypass air flows though the orifice 51 the pressure is reduced to a level P₃ thus lowering the concentration of moisture in the air. The bypass air at pressure P₃ flows into the chamber at a pressure P₂ which is less than the pressure P₁ in chamber 47 and then discharges to the atmosphere at pressure P₀ which is less than pressure P₂. Thus, the pressure of the air P₃, is greater than pressure P₂, which is greater than the ambient pressure P₀ causing a continual flow of bypass air to the atmosphere. More importantly, the flow of bypass air with a lower moisture concentration past one side of membrane 50 and the presence of compressed air at a higher moisture concentration on the other side of a membrane 50 allows passage of moisture through the membrane 50 but prevents oxygen and nitrogen, which are the main components of the compressed air, to flow therethrough thus causing the compressed air to remain at a high-pressure as the high-pressure air loses moisture through the membrane 50. By removing a portion of the moisture of the compressed air with the membrane dehumidifier 42, the amount of moisture in the compressed air can be reduced to a level where no or minimal condensation occurs thus eliminating or inhibiting problems of ice formation in the system.

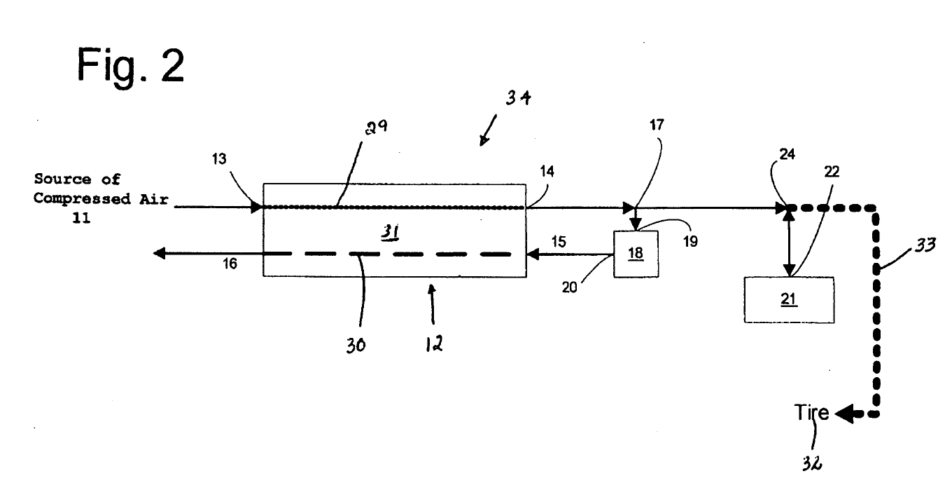

FIGS. 1 and 1A show examples of an air station that does not use an air reservoir and FIGS. 2-6 show examples of compressed air stations using either inline or offline air reservoir to store compressed air.

FIG. 2 shows a schematic diagram of an example of a membrane device system 34 for drying compressed air for use in pneumatic applications such as filling tires or operating pneumatic equipment where a portion of the compressed air is expanded and is used to dry the compressed air. Membrane device system 34 contains the membrane device 12 of FIG. 1. However, in membrane device system 34, tee 17 is no longer in direct fluid communication with tire 32 but instead is now in fluid communication with a tee 24. It is noted that tee 17 is still in fluid communication with the outlet 14 of membrane device 12 and the inlet 19 of a sweep control device 18. As shown in FIG. 2, tee 24 is in fluid communication with port 22 of an offline air reservoir 21 and with the tire 32, through the air hose 33. It should be noted that the port 22 functions as either an inlet or outlet for reservoir 21. While cooling may occur in the air hose 33, the removal of some of the water vapor in the compressed air by the membrane device 12 can reduce or eliminate condensation and frost and ice formation in the air hose 33.

The offline air reservoir 21, in membrane device system 34, can store or release compressed air. Storing compressed air in air reservoir 21 allows one to supply additional compressed air during times of high demand. For example, the use of stored air in the offline reservoir 21 can help speed the filling of tires, since the reservoir 21 can supply additional compressed air as a tire is being filled. As a person moves to fill another tire thus stopping the flow of air though hose 33, the reservoir 21 can be refilled with the dry compressed air emanating from outlet 14. The supplying of additional compressed air during times of high demand not only aids in filling a tire more quickly, but it can also even out the compressed air flow through membrane device 12, which helps membrane device 12 dry the compressed air by providing a more consistence flow of air through membrane devices 12. Also in systems where the source of compressed air 11 shuts off when not in use causing the system to depressurize, the reservoir 21 helps slow the rate of system pressurization, when the system starts up. The slowing of the rate of system pressurization helps reduce the stress on the membrane 31 and can prolong membrane life. While reservoir 21 is shown separate from the membrane device 12 for clarity purposes, examples of other embodiments may comprise an air reservoir surrounding the membrane device 12 and sharing common elements of the housing with the membrane device 12.

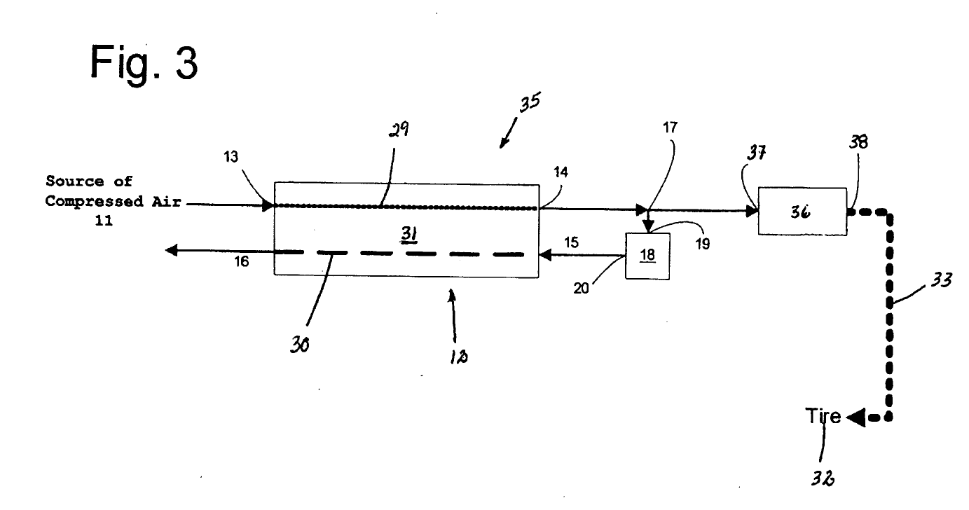

FIG. 3 shows a schematic diagram of another example of a membrane device system 35 for drying compressed air for filling tires. Membrane device system 35 comprises all the components of the membrane device system 10 of FIG. 1. However, in membrane device system 35, tee 17 is no longer in direct fluid communication with tire 32 but instead is in fluid communication with an inlet 37 of an inline reservoir 36 with reservoir 36 functioning similarly to the reservoir 21 of FIG. 2 in that compressed air is temporarily stored in an inline reservoir 36. An outlet 38 of the reservoir 36 is shown in fluid communication with the tire 32, through the air hose 33. It is noted that tee 17 is still in fluid communication with the first outlet 14 of membrane device 12 and the inlet 19 of a sweep control device 18 to reduce the pressure of the air delivered to the fluid pathway 30.

Unlike reservoir 21, which has a single port, the reservoir 36 has an inlet port 37 of which is spaced from the outlet port 38 of reservoir 36. By having a separate or spaced inlet port 37 and outlet port 38, the compressed air is forced to flow through the reservoir 36. Use of an air reservoir 36 is beneficial for systems that depressurize when not in use. In such systems when the system starts up and pressurizes, the first air flowing through the membrane device 12 will not be dried as much due to low-pressure and thus the first air filling the reservoir 36 will not be as dry as the later air flowing into the reservoir 36. By forcing the air to flow through the reservoir 36 on the way to filling tire 32, the initial less dry air is eventually cleared from the system 35 and replaced with drier air.

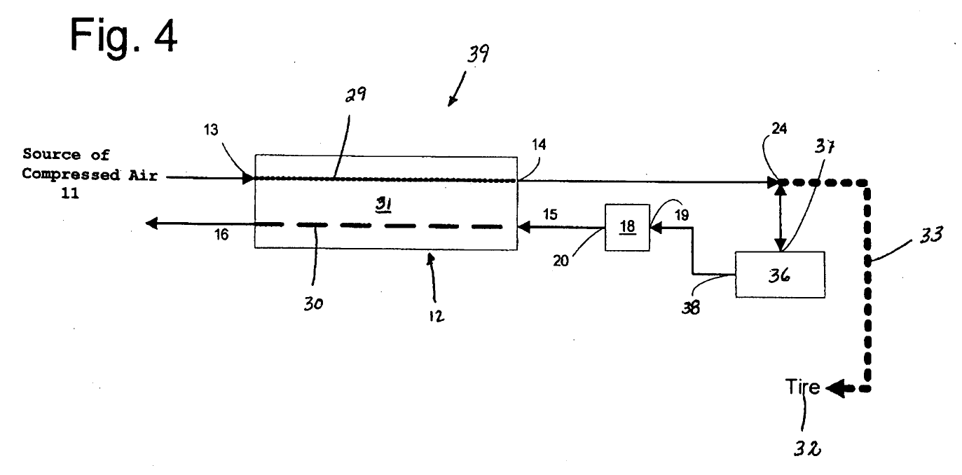

FIG. 4 shows a schematic diagram of another example of a membrane device system 39 for drying compressed air for filling tires. Membrane device system 39 contains most of the components of the membrane device system 10 of FIG. 1. However, in membrane device system 39, tee 17 is removed from the system 39. The first outlet 14 of the membrane device 12 is now in fluid communication with a Tee 24. Tee 24 is also in fluid communication with an air offline reservoir 36 via port 37 and also in fluid communication with tire 32 via hose 33. The outlet 38 of the air reservoir 36 is in fluid communication with the inlet 19 of the flow control device 18. A feature of membrane device system 39 is that the compressed air is forced to flow through the air reservoir 36 in the process of supplying sweep air to membrane device 12. The flow of air through reservoir 36 is beneficial for air supply systems that are depressurized when not in use. In such systems when the system starts up and pressurizes the lines, the first air through the membrane device will not have as much water vapor removed and thus the first air filling the reservoir 36 will not be as dry as later air filling the reservoir. By forcing the air to flow through the reservoir 36 in supplying the sweep air, this initial less dry air is cleared from the system and replaced with dry air.

FIG. 4 shows the sweep control device 18 has a high-pressure inlet 19, which is supplied with the compressed air in the reservoir 36. Sweep control device 18 allows a portion of the dried compressed air in tee 24 to decompress and pass through from the high-pressure inlet 19 to the low-pressure outlet 20. The decompression dries the air further since the density of the air decreases while the amount of water vapor in the air remains constant. The sweep control device 18 may be as simple as a fixed orifice or number of orifices. Sweep control device 18 is shown located external to the membrane device 12. In the configuration shown one can use a simple design that allows air flow therethrough which is proportional to the absolute pressure of the compressed air or the pressure differential between the compressed air in flow pathway 29 and the air in flow pathway 30, or it may be a complex design that allows more air flow through flow pathway 29 at lower pressure and less air flow pathway 30 at higher pressure, in order to get enhance performance of membrane device 12. In the system the sweep control device 18 automatically adjusts the pressure of the compressed air discharging therefrom based on system pressure in air reservoir 36.

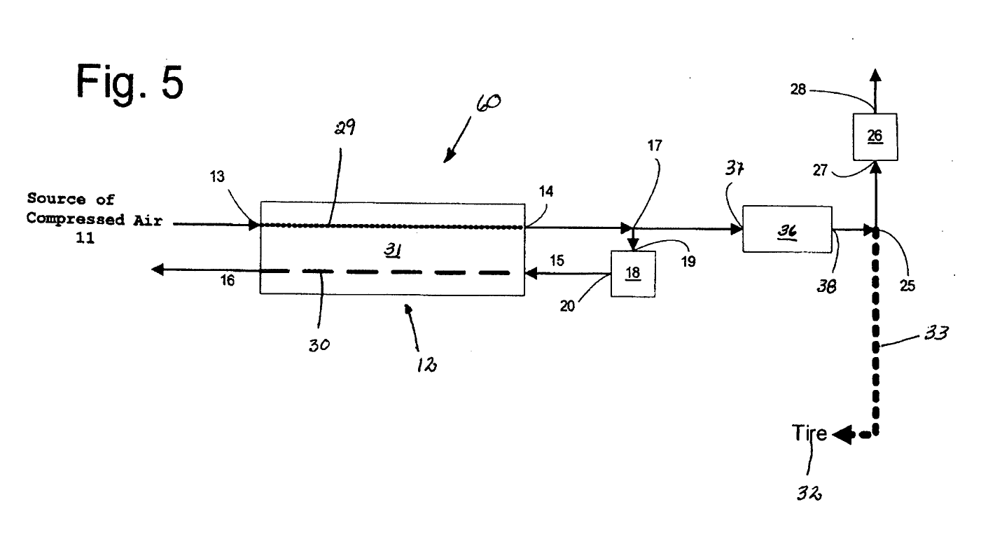

FIG. 5 shows a schematic diagram of an example of another embodiment of a membrane device system 60 for drying compressed air for filling tires. Membrane device system 60 contains most of the components of the membrane device system 35 of FIG. 3. However, the outlet 38 of the inline air reservoir 36 is in fluid communication with a tee 25 instead of tire 32. The tee 25 is shown in fluid communication with a high-pressure inlet 27 of a pressure relief valve 26 and with tire 32, through the air hose 33. In regards to pressure relief valve 26, pressure relief valve 26 also includes a low-pressure outlet 28.

A pressure relief valve can be used in systems where the compressed air source is a local compressed air source which is used for intermittingly filling tires. When the air from the compressed air source 11 is not being used to fill the reservoir 36 or tire 32, or the demand is less than that supplied by the compressed air source 11, the air from the compressed air source 11 may need to be vented in order to keep the system from over pressurizing. Usually the pressure relief valve 26 is located on the compressed air source itself, but by locating the pressure relief valve as shown in FIG. 5, air is forced through the system 60 when the pressure relief valve 26 is venting air to the atmosphere. This arrangement has the advantage of providing additional drying to the system. When the pressure relief valve 26 is relieving air, the air pressure in system 60 is at its highest pressure. In general, membrane dryers have greater water removal efficiency at high-pressure than at low pressure, thus the compressed air supplied by the membrane device 12 through the first outlet 14 when the pressure is high will be quite dry. Since the compressed air is forced to flow through the reservoir 36 before being able to exit the system through the pressure relief valve 26, it helps ensure that the compressed air in the air reservoir 36 is very dry. Thus, when a demand for air to fill tire 32 resumes the very dry compressed air stored in the air reservoir 36 can be supplied to air hose 33. If demand for air to fill the tire 32 does not resume, and the system 60 shuts down and depressurizes, the very dry air stored in the reservoir 36 dries out the system 60 as the dry air from reservoir 36 discharges through sweep control device 18.

While examples of the invention have been shown the invention also includes a method for removing moisture from compressed air to inhibit or prevent freezing of a tire filling system under freezing conditions. As shown in FIG. 2 such a method comprises: (1) directing a compressed air into a high-pressure chamber 47 having a membrane 50 on at least one side of the high-pressure chamber 47; and (2) directing the compressed air from the high-pressure chamber 47 into a diverter 57 to divert a portion of the compressed air into compressed air at a lower pressure and then directing portion of the compressed air at a lower pressure into a low-pressure chamber 49 located on an opposite side of the membrane 50 to allow moisture from the compressed air in the high-pressure chamber 47 to migrate into the compressed air at a low-pressure in the low-pressure chamber 49 thus reducing the moisture content of the compressed air in the high-pressure chamber 47. The aforementioned method further includes the step of (3) lowering the moisture content of the air on-the-go.

While the invention has been describe in use with air stations for filing tires it is understood other types of air stations, for example, air stations for supplying compressed air to pneumatic equipment can also benefit from the invention. In the examples shown the compressed air at a reduced pressure is obtained after the air has been dried by flowing through the membrane although if desired the sweep air can also be supplied by decompressing a portion of the supplied air before drying the air, but this may render the sweep air less dry and may lead to slightly worse membrane device performance.

We claim:

1. A membrane device system for supplying compressed air with reduced moisture content comprising:
a source of compressed air;
a membrane device having a selective membrane with a greater selectivity of water vapor over both nitrogen and oxygen, said membrane device having a first fluid pathway and a second fluid pathway separated by said selective membrane with said first fluid pathway in fluid communication with said source of compressed air;
a sweep control device having a high-pressure inlet and a low-pressure outlet, said low-pressure outlet of said sweep control device in fluid communication with said second fluid pathway of said membrane device to direct a portion of the compressed air from said first fluid pathway at a reduced pressure through said second fluid pathway to enable water vapor in the compressed air in the first fluid pathway to be transferred through the selective membrane into the compressed air at a reduced pressure in said second fluid pathway to thereby reduce the moisture content of the compressed air in the first fluid pathway; and
an air hose for delivery of the compressed air with reduced moisture content.

2. The membrane device system of claim 1 wherein the membrane device comprises a flat sheet membrane, a spiral wound membrane or a hollow fiber membrane.

3. The membrane device system of claim 1 wherein the flow of the compressed air in said first fluid pathway is counter-current to the flow of compressed air at a reduced pressure in said second fluid pathway and the compressed air discharging from said first fluid pathway is dried compressed air.

4. The membrane device system of claim 1 wherein said sweep control device includes an orifice.

5. The membrane device system of claim 1 wherein said first fluid pathway of said membrane device is in fluid communication with said high-pressure inlet of said sweep control device.

6. The membrane device system of claim 1 including a reservoir for storing compressed air from said membrane device.

7. The membrane device system of claim 6 wherein said first fluid pathway of said membrane device is in fluid communication with said reservoir and said reservoir is in fluid communication with said air hose.

8. The membrane device system of claim 6 wherein said membrane device is in fluid communication with both said reservoir and said air hose and said reservoir is in fluid communication with said high-pressure inlet of said sweep control device.

9. The membrane device system of claim 6 wherein the sweep control device comprises a pressure relief valve having a high-pressure inlet in fluid communication with said air reservoir.

10. The membrane device system of claim 6 wherein the said reservoir is offline and the compressed air flows either or out of said reservoir.

11. The membrane device system of claim 6 wherein the sweep control device receives a portion of a high pressure compressed air from the first fluid pathway through a tee located between said membrane device and said reservoir.

12. The membrane device system of claim 1 wherein the membrane has a selectivity of water vapor over both nitrogen and oxygen of at least 10.

13. A vehicle air station for supplying compressed air wherein the moisture in the compressed air is reduced to inhibit or prevent condensation during delivery of the compressed air comprising:
a housing having a high-pressure inlet, a high-pressure outlet, a low-pressure inlet and a low-pressure outlet;
a source of compressed air for directing high-pressure compressed air into said high-pressure inlet;
a selective membrane located in said housing with said membrane having a high-pressure chamber on a first side of said membrane and a low-pressure chamber on a second side of said membrane;
a diverter for directing a portion of compressed air at a high-pressure into a sweep control device to reduce the pressure of the portion of compressed air and then directing the portion of the compressed air at the reduced pressure into the low-pressure chamber to enable moisture from the high-pressure compressed air in the high-pressure chamber to pass through the membrane into the compressed air at the reduced pressure in the low pressure chamber thereby reducing the moisture content of the high-pressure compressed air in the high pressure chamber; and
an air hose for directing the high-pressure compressed air at reduced moisture content into a tire.

14. The vehicle air station of claim 13 wherein the diverter comprises a bypass line having an orifice therein.

15. The vehicle air station of claim 13 including an air reservoir for storage of the high-pressure air compressed air with reduced moisture content.

16. A method for supplying compressed air of reduced moisture content in a pneumatic air station subject to freezing conditions comprising:
directing compressed air into a high pressure fluid chamber having a membrane on at least one side of a high-pressure chamber; and
directing the compressed air from the high-pressure chamber into a diverter to reduce the pressure of a portion of the high pressures compressed air;
directing the portion of the high pressure compressed air at a reduced pressure into a low-pressure chamber located on an opposite side of said membrane to allow moisture from the compressed air in the high-pressure chamber to migrate into the compressed air at a reduced pressure in the low-pressure chamber thus reducing the moisture content of the compressed air.

17. The method of claim 16 wherein the step of directing the high pressure into a diverter includes directing the portion of the high-pressure compressed air through an orifice.

18. The method of claim 17 including the step of directing the high-pressure compressed air into a flexible air hose.

19. The method of claim 18 including the step of directing the high-pressure compressed air into an air reservoir.

20. The method of claim 19 wherein the step of directing the high pressure air into the air reservoir comprises directing the high pressure compressed air into an off line air reservoir.

21. The method of claim 20 wherein the moisture content of the compressed air is reduced on-the-go.

22. The method of claim 18 wherein the compressed air with reduced moisture content is directed into a tire.
